(19) United States
(12) Patent Application Publication
(10) Pub. No.: US 2024/0343847 A1
(43) Pub. Date: Oct. 17, 2024

(54) POLYETHYLENE COMPOSITION FOR BLOW MOLDING HAVING HIGH SWELL RATIO, IMPACT RESISTANCE AND TENSILE MODULUS

(71) Applicant: Basell Polyolefine GmbH, Wesseling (DE)

(72) Inventors: Diana Doetsch, Bad Kreuznach (DE); Bernd Lothar Marczinke, Roemerberg (DE); Gerhardus Meier, Frankfurt/M (DE); Ulf Schueller, Weiterstadt (DE); Elke Damm, Bad Vilbel (DE); Claudio Fibla, Pijnacker (NL)

(73) Assignee: Basell Polyolefine GmbH, Wesseling (DE)

(21) Appl. No.: 18/580,415

(22) PCT Filed: Jul. 5, 2022
(86) PCT No.: PCT/EP2022/068547

§ 371 Date: Jan. 18, 2024

(30) Foreign Application Priority Data
Jul. 23, 2021 (EP) 21187448.2

(51) Int. Cl. C08F 210/16; C08L 23/06; C08L 23/08

(52) U.S. Cl. CPC C08F 210/16; C08L 23/06; C08L 23/0815; C08L 2205/025; C08L 2314/02

(57) ABSTRACT

A polyethylene composition having the following features:
1) a density from 0.957 to 0.968 g/cm³;
2) a ratio MIF/MIP from 12 to 30;
3) a MIF from 41 to 60 g/10 min.;
4) a long-chain branching index, LCBI, equal to or greater than 0.45; and
5) a ratio (η_{0.02}/1000)/LCBI from 45 to 75.

### FIELD OF THE INVENTION

In general, the present disclosure relates to the field of chemistry. More specifically, the present disclosure relates to polymer chemistry. In particular, the present disclosure relates to a polyethylene composition and articles blow-molded therefrom.

### BACKGROUND OF THE INVENTION

In some instances, properties such as swell ratio, impact resistance, and tensile modulus impact the selection of polyethylene compositions for various applications. In some instances, surface smoothness and gel content affect the selection of polyethylene compositions for preparing various articles. Moreover and in some instances, melt flow index determines processability of polyethylene compositions.

### SUMMARY OF THE INVENTION

In a general embodiment, the present disclosure provides a polyethylene composition having the following features:
1) a density from 0.957 to 0.968 g/cm³, alternatively from 0.958 to 0.968 g/cm³, alternatively from 0.959 to 0.965 g/cm³, determined according to ISO 1183-1:2012 at 23° C.;
2) a ratio MIF/MIP from 12 to 30, alternatively from 15 to 25, alternatively from 15 to 23, where MIF is the melt flow index at 190° C. with a load of 21.60 kg, and MIP is the melt flow index at 190° C. with a load of 5 kg, both determined according to ISO 1133-1 2012-03;
3) a MIF from 41 to 60 g/10 min., alternatively from 43 to 55 g/10 min., alternatively from 45 to 55 g/10 min.;
4) a long-chain branching index, LCBI, equal to or greater than 0.45, alternatively equal to or greater than 0.50, wherein LCBI is the ratio of the measured mean-square radius of gyration R_{g}, measured by GPC-MALLS, to the mean-square radius of gyration for a linear PE, having the same molecular weight; and
5) a ratio (η_{0.02}/1000)/LCBI, which is between 10.02 divided by 1000 and LCBI, from 45 to 75, alternatively from 50 to 70.

### BRIEF DESCRIPTION OF THE DRAWINGS

These and other features of the present disclosure will become better understood in view of the following description and appended claims, and accompanying drawing figure where:

FIG. 1 is a simplified process-flow diagram of two serially connected gas-phase reactors for use in ethylene polymerization processes to produce various polyethylene compositions.

It should be understood that the various embodiments are not limited to the arrangements and instrumentality shown in the drawing figure.

### DETAILED DESCRIPTION OF THE INVENTION

As used herein, the expression “polyethylene composition” embraces, as alternatives, both a single ethylene polymer and an ethylene polymer composition, including a composition of two or more ethylene polymer components. In some embodiments, the ethylene polymer components have different molecular weights. As used herein, this composition may be referred to as “bimodal” or “multimodal” polymer.

In some embodiments, the present polyethylene composition is made from or containing one or more ethylene copolymers.

The features herein defined, including the previously defined features 1) to 5), are referred to as features of the ethylene polymer or ethylene polymer composition. In some embodiments, the addition of other components, like additives, modify one or more of the features.

It is believed that the ratio MIF/MIP provides a rheological measure of molecular weight distribution.

It is believed that another measure of the molecular weight distribution is provided by the ratio Mw/Mn, where Mw is the weight average molecular weight and Mn is the number average molecular weight, measured by GPC (Gel Permeation Chromatography).

In some embodiment, the Mw/Mn values for the present polyethylene composition range from 25 to 45, alternatively from 30 to 40.

In some embodiments, ranges of LCBI values are:
from 0.45 to 0.65; alternatively
from 0.45 to 0.60; alternatively
from 0.50 to 0.65; alternatively
from 0.50 to 0.60.

In some embodiments, the present polyethylene composition has a feature selected from the following additional features.
a η_{0.02} from 25,000 to 38,000 Pa·s, alternatively from 25,000 to 34,000 Pa·s., wherein η_{0.02} is the complex shear viscosity at an angular frequency of 0.02 rad/s, measured with dynamic oscillatory shear in a plate-plate rotational rheometer at a temperature of 190° C.;
a comonomer content equal to or less than 0.3% by weight, alternatively from 0.05 to 0.3% by weight, with respect to the total weight of the composition;
a Mw equal to or higher than 230,000 g/mol, alternatively from 230,000 to 400,000 g/mol;
a Mz equal to or higher 1,000,000 g/mol, alternatively from 1,000,000 g/mol to 2,500,000 g/mol, wherein Mz is the z-average molecular weight, measured by GPC;
a Mz/Mw equal to or higher than 5.8, alternatively equal to or higher than 6.3, alternatively equal to or higher than 6.4, alternatively equal to or higher than 6.5, alternatively from 5.8 to 9, alternatively from 6.3 to 9, alternatively from 6.4 to 9, alternatively from 6.5 to 9;
a MIE equal to or lower than 0.8 g/10 min., alternatively from 0.8 to 0.1 g/10 min., wherein MIE is the melt flow index at 190° C. with a load of 2.16 kg, determined according to ISO 1133-1 2012-03;
a MIP from 1 to 10 g/10 min., alternatively from 1.5 to 8 g/10 min., alternatively from 2 to 8 g/10 min.;
an ER equal to or higher than 1, alternatively equal to or higher than 1.5, alternatively from 1 to 8, alternatively from 1.5 to 8;
an ET equal to or lower than 25, alternatively from 3 to 25, alternatively from 7 to 25; and
a HMWcopo index from 0.1 to 3, alternatively from 0.1 to 2;
wherein the HMWcopo index is determined according to the following formula:

HMWcopo=(η_{0.02}=t_{maxDSC})/(10\hat{ }5)
wherein
η_{0.02} is the complex shear viscosity at an angular frequency of 0.02 rad/s, measured with dynamic oscillatory shear in a plate-plate rotational rheometer at a temperature of 190° C.; and
t_{maxDSC} is the time, in minutes, to reach the maximum value of heat flow (in mW) of crystallization (time at which the maximum crystallization rate is achieved, equivalent to the t1/2 crystallization half-time) at a temperature of 124° C. under quiescent conditions, measured in isothermal mode in a differential scanning calorimetry apparatus, DSC.

In some embodiments, the comonomer or comonomers present in the ethylene copolymers are selected from olefins having formula CH₂═CHR wherein R is an alkyl radical, linear or branched, having from 1 to 10 carbon atoms.

In some embodiments, the comonomer or comonomers are selected from the group consisting of propylene, butene-1, pentene-1, 4-methylpentene-1, hexene-1, octene-1, and decene-1. In some embodiments, the comonomer is hexene-1.

In some embodiments, the polyethylene composition is made from or containing:
A) 30-70% by weight, alternatively 40-60% by weight, of an ethylene homopolymer or copolymer with a density equal to or greater than 0.960 g/cm³ and a MIE of 65 g/10 min. or higher, alternatively of 75 g/10 min. or higher, alternatively from 65 to 100 g/10 min., alternatively from 75 to 100 g/10 min.; and
B) 30-70% by weight, alternatively 40-60% by weight, of an ethylene copolymer, having a MIE value lower than the MIE value of component A), alternatively lower than 0.5 g/10 min.

The above percent amounts are given with respect to the total weight of A)+B). In some embodiments, component A) is an ethylene homopolymer.

In some embodiments, the difference between the density value of component A) and the density value of the polyethylene composition is of equal to or lower than 15 kg/m³, alternatively from 15 to 5 kg/m³.

In some embodiments, the polyethylene composition is used for producing articles of manufacture. In some embodiments, the present polyethylene is used for producing blow molded articles. In some embodiments, the blow-molded articles are blow molded containers with a capacity from 200 to 5000 cm³. In some embodiments, the blow-molded containers are blow molded dairy and beverage bottles.

In some embodiments, the polyethylene compositions have the following properties.
a swell ratio higher than 180%, alternatively of 185% or higher;
an AZK −30° C. of 70 kJ/m² or higher, alternatively from 70 to 100 kJ/m²;
a Tensile Modulus (E-Modulus), measured according to ISO 527-2/1B/50, of 1400 MPa or higher, alternatively of 1470 MPa or higher, alternatively from 1400 to 1800 MPa, alternatively from 1470 to 1800 MPa;
an amount of gels/m², having a gel diameter of higher than 700 μm of less than 1; and
an amount of gels/m², having a gel diameter of higher than 450 μm of less than 2.5.

In some embodiments, the upper limit of the swell ration range is 220%.

In some embodiments, the blow-molding process is carried out by first plasticizing the polyethylene composition in an extruder at temperatures in the range from 180 to 250° C. and then extruding the polyethylene composition through a die into a blow mold, where the polyethylene composition is cooled.

In some embodiments, the polyethylene composition is prepared by a gas phase polymerization process in the presence of a Ziegler-Natta catalyst.

As used herein, a Ziegler-Natta catalyst is made from or containing the product of a reaction of an organometallic compound of group 1, 2 or 13 of the Periodic Table of elements with a transition metal compound of groups 4 to 10 of the Periodic Table of Elements (new notation). In some embodiments, the transition metal compound is selected from the group consisting of compounds of Ti, V, Zr, Cr, and Hf. In some embodiments, the transition metal compound is supported on MgCl₂.

In some embodiments, the catalysts are made from or containing the product of the reaction of the organometallic compound of group 1, 2 or 13 of the Periodic Table of elements, with a solid catalyst component made from or containing a Ti compound supported on MgCl₂.

In some embodiments, the organometallic compounds are organo-Al compounds.

In some embodiments, the polyethylene composition is obtainable by using a Ziegler-Natta polymerization catalyst, alternatively a Ziegler-Natta catalyst supported on MgCl₂, alternatively a Ziegler-Natta catalyst made from or containing the product of a reaction of:
a) a solid catalyst component made from or containing a Ti compound and an electron donor compound ED supported on MgCl₂;
b) an organo-Al compound; and optionally
c) an external electron donor compound EDₑₓₜ.

In some embodiments and in component a), the ED/Ti molar ratio ranges from 1.5 to 3.5 and the Mg/Ti molar ratio is higher than 5.5, alternatively from 6 to 80.

In some embodiments, the titanium compounds are the tetrahalides or the compounds of formula TiXₙ(OR¹)₄₋ₙ, where 0≤n≤3, X is halogen, and R¹ is C₁-C₁₀ hydrocarbon group. In some embodiments, the halogen is chlorine. In some embodiments, the titanium compound is titanium tetrachloride.

In some embodiments, the ED compound is selected from the group consisting of alcohol, ketones, amines, amides, nitriles, alkoxysilanes, aliphatic ethers, and esters of aliphatic carboxylic acids.

In some embodiments, the ED compound is selected from the group consisting of amides, esters and alkoxysilanes.

In some embodiments, the ED compound is an ester. In some embodiments, the esters are alkyl esters of C₁-C₂₀ aliphatic carboxylic acids, alternatively C₁-C₈ alkyl esters of aliphatic mono carboxylic acids. In some embodiments, the esters are selected from the group consisting of ethylacetate, methyl formiate, ethylformiate, methylacetate, propylacetate, i-propylacetate, n-butylacetate, and i-butylacetate. In some embodiments, the ethers are aliphatic ethers, alternatively C₂-C₂₀ aliphatic ethers. In some embodiments, the ether is tetrahydrofuran (THF) or dioxane.

In some embodiments and in the solid catalyst component, MgCl₂ is the support. In some embodiments, a minor amount of additional carriers is used. In some embodiments, MgCl₂ is used. In some embodiments and as precursors, Mg compounds are reacted with halogenating compounds, thereby forming MgCl₂. In some embodiments, MgCl₂ is used in active form as a support for Ziegler-Natta catalysts, as described in U.S. Pat. Nos. 4,298,718 and 4,495,338.

In some embodiments, the solid catalyst component a) is obtained by first contacting the titanium compound with the MgCl₂, or a precursor Mg compound, optionally in the presence of an inert medium, thereby preparing an intermediate product a′) containing a titanium compound supported on MgCl₂. In some embodiments, the intermediate product a′) is then contacted with the ED compound, which is added to the reaction mixture alone or in a mixture with other compounds, wherein the ED-treated product represents the main component, optionally in the presence of an inert medium.

As used herein, the term “main component” refers to the ED compound in terms of molar amount, with respect to the other possible compounds, excluding inert solvents or diluents used to handle the contact mixture. In some embodiments, the ED treated product is subjected to washings with the solvents, thereby recovering the final product. In some embodiments, the treatment with the ED compound is repeated one or more times.

In some embodiments, a precursor of MgCl₂ is a Mg compound of formula MgR′₂ where the R′ groups is independently C₁-C₂₀ hydrocarbon groups optionally substituted, OR groups, OCOR groups, chlorine, wherein R is a C₁-C₂₀ hydrocarbon groups optionally substituted, providing that the R′ groups are not simultaneously chlorine. In some embodiments, the precursors are the Lewis adducts between MgCl₂ and Lewis bases. In some embodiments, the adducts are MgCl₂ (R″OH)ₘ adducts, wherein R″ groups are C₁-C₂₀ hydrocarbon groups, alternatively C₁-C₁₀ alkyl groups, and m is from 0.1 to 6, alternatively from 0.5 to 3, alternatively from 0.5 to 2. In some embodiments, the adducts are obtained by mixing alcohol and MgCl₂ in the presence of an inert hydrocarbon immiscible with the adduct, operating under stirring conditions at the melting temperature of the adduct (100-130° C.). Then, the emulsion is quenched, thereby causing the solidification of the adduct in form of spherical particles. In some embodiments, the preparation of these spherical adducts occur as described in U.S. Pat. No. 4,469,648, 4,399,054, or Patent Cooperation Treaty Publication No. WO98/44009. In some embodiments, the spherulization occurs by a spray cooling method as described in U.S. Pat. Nos. 5,100,849 and 4,829,034.

In some embodiments, the MgCl₂ (R″OH)ₘ adducts are MgCl₂·(EtOH)ₘ adducts wherein m is from 0.15 to 1.7 and obtained by subjecting the adducts with a higher alcohol content to a thermal dealcoholation process carried out in nitrogen flow at temperatures between 5° and 150° C., until the alcohol content is reduced. In some embodiments, the adducts are prepared as described in European Patent No. EP 395083.

In some embodiments, the dealcoholation is carried out chemically by contacting the adduct with compounds reacting with the alcohol groups.

In some embodiments, these dealcoholated adducts are characterized by a porosity (measured by mercury method) due to pores with radius up to 0.1 μm ranging from 0.15 to 2.5 cm³/g, alternatively from 0.25 to 1.5 cm³/g.

In some embodiments, these adducts are reacted with the previously-mentioned TiXₙ(OR¹)₄₋ₙ compound (or possibly mixtures thereof). In some embodiments, the TiXₙ(OR¹)₄₋ₙ compound is titanium tetrachloride. In some embodiments, the reaction with the Ti compound is carried out by suspending the adduct in TiCl₄. In some embodiments, the TiCl₄ is cold. The mixture is heated up to temperatures ranging from 80-130° C. and maintained at this temperature for 0.5-2 hours. In some embodiments, the treatment with the titanium compound is carried out one or more times. In some embodiments, the treatment with the titanium compound is repeated twice. In some embodiments, the treatment with the titanium compound is carried out in the presence of an electron donor compound. At the end of the process, the solid is recovered by separation of the suspension. In some embodiments, the separation is achieved by settling and removing of the liquid, filtration, or centrifugation. In some embodiments, the intermediate solid is subjected to washings with solvents. In some embodiments, the washings are carried out with inert hydrocarbon liquids. In some embodiments, the washings use more polar solvents such as halogenated hydrocarbons. In some embodiments, the polar solvents have a higher dielectric constant than the inert hydrocarbon liquids.

In some embodiments, the intermediate product is then brought into contact with the ED compound under conditions for fixing an amount of donor on the solid. In some embodiments, the donor is used in a molar ratio with respect to the Ti content in the intermediate product ranging from 0.5 to 20, alternatively from 1 to 10. In some embodiments, the contact is carried out in a liquid medium such as a liquid hydrocarbon. In some embodiments, the temperature at which the contact takes place is in the range from −10° to 150° C., alternatively from 0° to 120° C. In some embodiments, temperatures causing the decomposition or degradation of any reagent are avoided even if the temperature fall within the range. In some embodiments, the time of the treatment varies depending on conditions such as nature of the reagents, temperature, and concentration. In some embodiments, this contact step lasts from 10 minutes to 10 hours, alternatively from 0.5 to 5 hours. In some embodiments and to further increase the final donor content, this step is repeated one or more times. At the end of this step, the solid is recovered by separation of the suspension. In some embodiments, the separation is achieved by settling and removing of the liquid, filtration, or centrifugation. In some embodiments, the solid is subjected to washings with solvents. In some embodiments, the washings are carried out with inert hydrocarbon liquids. In some embodiments, the washings use more polar solvents such as halogenated or oxygenated hydrocarbons. In some embodiments, the polar solvents have a higher dielectric constant than the inert hydrocarbon liquids.

In some embodiments, the solid catalyst component is converted into catalysts for the polymerization of olefins by reacting the solid catalyst component with an organometallic compound of group 1, 2 or 13 of the Periodic Table of elements, alternatively with an alkyl-Al compound.

In some embodiments, the alkyl-Al compound is selected from the group consisting of trialkyl aluminum compounds, alkylaluminum halides, alkylaluminum hydrides, and alkylaluminum sesquichlorides. In some embodiments, the trialkyl aluminum compounds are selected from the group consisting of triethylaluminum, triisobutylaluminum, tri-n-butylaluminum, tri-n-hexylaluminum, and tri-n-octylaluminum. In some embodiments, the alkylaluminum sesquichlorides are selected from the group consisting of AlEt₂Cl and Al₂Et₃Cl₃. In some embodiments, the alkylaluminum sesquichlorides are used in mixture with trialkyl aluminum compounds.

In some embodiments, the external electron donor compound EDₑₓₜ is the same as or different from the ED used in the solid catalyst component a). In some embodiments, the external electron donor compound EDₑₓₜ is selected from the group consisting of ethers, esters, amines, ketones, nitriles, silanes, and their mixtures. In some embodiments, the external electron donor compound EDₑₓₜ is selected from the C₂-C₂₀ aliphatic ethers, alternatively cyclic ethers. In some embodiments, the cyclic ethers have 3-5 carbon atoms. In some embodiments, the ethers are selected from the group consisting of tetrahydrofuran and dioxane.

In some embodiments, the catalyst is prepolymerized by producing reduced amounts of polyolefin. In some embodiments, the polyolefin is polypropylene or polyethylene. In some embodiments, the prepolymerization is carried out before adding the electron donor compound ED, that is, subjecting the intermediate product a′) to prepolymerization. In some embodiments, the solid catalyst component a) is subjected to prepolymerization.

In some embodiments, the amount of prepolymer produced is up to 500 g per g of intermediate product a′) or of component a). In some embodiments, the amount of prepolymer produced is from 0.5 to 20 g per g of intermediate product a′).

In some embodiments, the prepolymerization is carried out with a cocatalyst. In some embodiments, the cocatalysts are organoaluminum compounds.

In some embodiments, the prepolymerization is carried out at temperatures from 0 to 80° C., alternatively from 5 to 70° C., in the liquid or gas phase.

In some embodiments, the present disclosure provides a process for preparing the polyethylene composition including the steps of, in any order:
a) polymerizing ethylene, optionally together with one or more comonomers, in a gas-phase reactor in the presence of hydrogen; and
b) copolymerizing ethylene with one or more comonomers in another gas-phase reactor in the presence of an amount of hydrogen less than step a),
wherein, in at least one of the gas-phase reactors, the growing polymer particles flow upward through a first polymerization zone (riser) under fast fluidization or transport conditions, leave the riser, and enter a second polymerization zone (downcomer) through which the polymer particles flow downward under the action of gravity, leave the downcomer, and are reintroduced into the riser, thereby establishing a circulation of polymer between the two polymerization zones.

In some embodiments and in the first polymerization zone (riser), fast fluidization conditions are established by feeding a gas mixture made from or containing one or more olefins (ethylene and comonomers) at a velocity higher than the transport velocity of the polymer particles. In some embodiments, the velocity of the gas mixture is between 0.5 and 15 m/s, alternatively between 0.8 and 5 m/s. As used herein, the terms “transport velocity” and “fast fluidization conditions” are as defined in “D. Geldart, Gas Fluidisation Technology, page 155 et seq., J. Wiley & Sons Ltd., 1986”.

In some embodiments and in the second polymerization zone (downcomer), the polymer particles flow under the action of gravity in a densified form, thereby achieving high values of density of the solid (mass of polymer per volume of reactor), which approach the bulk density of the polymer.

The polymer flows vertically down through the downcomer in a plug flow (packed flow mode), thereby entraining small quantities, if any, of gas between the polymer particles.

In some embodiments, the ethylene polymer of step a) has a molecular weight lower than the ethylene copolymer obtained in step b).

In some embodiments, a copolymerization of ethylene to produce a relatively low molecular weight ethylene copolymer (step a) is performed upstream of the copolymerization of ethylene to produce a relatively high molecular weight ethylene copolymer (step b). In some embodiments and in step a), a gaseous mixture made from or containing ethylene, hydrogen, comonomer, and an inert gas is fed to a first gas-phase reactor, alternatively a gas-phase fluidized bed reactor. In some embodiments, the polymerization is carried out in the presence of the Ziegler-Natta catalyst.

In some embodiments, hydrogen is fed in an amount depending on the catalyst used. In some embodiments, hydrogen is fed in an amount sufficient to obtain, in step a), an ethylene polymer with a melt flow index MIE of 65 g/10 min. or higher. In some embodiments and in step a), the hydrogen/ethylene molar ratio is from 1 to 5, and the amount of ethylene monomer is from 2 to 20% by volume, alternatively from 5 to 15% by volume, based on the total volume of gas present in the polymerization reactor. In some embodiments, the remaining portion of the feeding mixture is represented by inert gases. In some embodiments, the remaining portion of the feeding mixture is represented by one or more comonomers. In some embodiments, inert gases dissipate the heat generated by the polymerization reaction and are selected from the group consisting of nitrogen and saturated hydrocarbons. In some embodiments, the inert gas is propane.

In some embodiments, the operating temperature in the reactor of step a) is between 5° and 120° C., alternatively between 65 and 100° C. In some embodiments, the operating pressure is between 0.5 and 10 MPa, alternatively between 2.0 and 3.5 MPa.

In some embodiments, the ethylene polymer obtained in step a) represents from 30 to 70% by weight of the total ethylene polymer produced in the overall process, that is, in the first and second serially connected reactors.

In some embodiments, the ethylene polymer coming from step a) and the entrained gas are passed through a solid/gas separation step, thereby preventing the gaseous mixture coming from the first polymerization reactor from entering the reactor of step b) (second gas-phase polymerization reactor). In some embodiments, the gaseous mixture is recycled back to the first polymerization reactor while the separated ethylene polymer is fed to the reactor of step b). In some embodiments, the polymer is fed into the second reactor on the connecting part between the downcomer and the riser. It is believed that feeding the polymer at this point does not affect negatively flow conditions.

In some embodiments, the operating temperature in step b) is in the range of 65 to 95° C., and the pressure is in the range of 1.5 to 4.0 MPa. In some embodiments and to broaden the molecular weight distribution of the final ethylene polymer, the reactor of step b) is operated by establishing different conditions of monomers and hydrogen concentration within the riser and the downcomer.

In some embodiments and in step b), the gas mixture entraining the polymer particles and coming from the riser is partially or totally prevented from entering the downcomer, thereby obtaining two different gas composition zones. In some embodiments, the obstruction of the gas mixture is achieved by feeding a gas and/or a liquid mixture into the downcomer through a line placed at a point of the downcomer. In some embodiments, the feeding of the gas and/or liquid mixture occurs in the upper part of the downcomer. In some embodiments, the gas and/or liquid mixture has a composition different from that of the gas mixture present in the riser. In some embodiments, the flow of the gas and/or liquid mixture is regulated, thereby generating an upward flow of gas counter-current to the flow of the polymer and acts as a barrier to the gas mixture entrained among the polymer particles coming from the riser. In some embodiments, the counter-current is generated at the top of the downcomer. In some embodiments, a mixture with low content of hydrogen is fed and produces the higher molecular weight polymer fraction in the downcomer. In some embodiments, one or more comonomers are fed to the downcomer of step b), optionally together with ethylene, propane, or other inert gases.

In some embodiments, the hydrogen/ethylene molar ratio in the downcomer of step b) is in the range between 0.01 and 0.2. In some embodiments, the ethylene concentration is from 0.5 to 15% by volume, alternatively 0.5-10% by volume, based on the total volume of gas present in the downcomer. In some embodiments, the comonomer concentration is from 0.01 to 0.5% by volume, based on the total volume of gas present in the downcomer. In some embodiments, the remaining portion of the gas present is propane or similar inert gases. In some embodiments, a relatively high amount of comonomer is bonded to the high molecular weight polyethylene fraction.

The polymer particles coming from the downcomer are reintroduced in the riser of step b).

In some embodiments, the polymer particles keep reacting in the absence of additional comonomer being fed to the riser, and the concentration of the comonomer drops to a range of 0.005 to 0.3% by volume, based on the total volume of gas present in the riser. In some embodiments, the comonomer content is controlled to obtain the density of the final polyethylene. In some embodiments and in the riser of step b), the hydrogen/ethylene molar ratio is in the range of 0.05 to 1, the ethylene concentration is between 5 and 20% by volume, based on the total volume of gas present in the riser. In some embodiments, the remaining portion of the gas present is propane or other inert gases.

In some embodiments, the polymerization process is as described in Patent Cooperation Treaty Publication No. WO2005019280.

### EXAMPLES

In some instances, the practice of the various embodiments, compositions and methods as provided herein are disclosed below in the following examples. These Examples are illustrative and are not intended to limit the scope of the appended claims in any manner whatsoever.

The following analytical methods are used to characterize the polymer compositions.

### Density

Determined according to ISO 1183-1:2012 at 23° C.

Complex shear viscosity η_{0.02} (eta (0.02)) ER and ET Measured at angular frequency of 0.02 rad/s and 190° C. as follows.

Samples were melt-pressed for 4 min under 200° C. and 200 bar into plates of 1 mm thickness. Disc specimens of a diameter of 25 mm were stamped and inserted in the rheometer, which was pre-heated at 190° C. The measurement was performed an Anton Paar MCR301 rotational rheometer, with a plate-plate geometry. A frequency-sweep was performed (after 4 min of annealing the sample at the measurement temperature) at T=190° C., under constant strain-amplitude of 5%, measuring and analyzing the stress response of the material in the range of excitation frequencies ω from 628 to 0.02 rad/s. The standardized basic software was utilized to calculate the rheological properties, that is, the storage-modulus, G′, the loss-modulus, G″, the phase lag δ (=arctan(G″/G′)), and the complex viscosity, η*, as a function of the applied frequency, namely η*(ω)=[G′(ω)²+G″(ω)²]^{1/2}/ω. The value of the latter at an applied frequency ω of 0.02 rad/s was the η_{0.02}.

ER was determined by the method described in R. Shroff and H. Mavridis, “New Measures of Polydispersity from Rheological Data on Polymer Melts,” J. Applied Polymer Science 57 (1995) 1605 (see also U.S. Pat. No. 5,534,472 at Column 10, lines 20-30). ER was calculated from:

$$ER = ( 1.781 * {10}^{- 3} ) * {G}^{′}$$

at a value of G″=5,000 dyn/cm².

When the lowest G″ value is greater than 5,000 dyn/cm², the determination of ER involves extrapolation and depends on the degree on nonlinearity in the log G′ versus log G″ plot. The temperature, plate diameter and frequency range were selected such that, within the resolution of the rheometer, the lowest G″ value was close to or less than 5,000 dyne/cm².

ET was determined by the method described in R. Shroff and H. Mavridis, “New Measures of Polydispersity from Rheological Data on Polymer Melts,” J. Applied Polymer Science 57 (1995) 1605-1626 as well.

ET was calculated from:

$$ET = {C}_{2} / {G}^{*} at tan δ = {C}_{3}$$

$$wherein :$$

$${G}^{*} = {[ {( {G}^{′} )}^{2} + {( {G}^{″} )}^{2} ]}^{1 / 2} ;$$

$$tan δ = {G}^{″} / {G}^{′} ;$$

$${C}_{2} = 1 {0}^{6} dyn / {cm}^{2} and {C}_{3} = 1.5 .$$

### HMWcopo Index

HMWcopo (High Molecular Weight Copolymer) Index is defined by the following formula:

HMWcopo=(η_{0.02}=t_{maxDSC})/(10\hat{ }5)

The t_{maxDSC} was determined using a Differential Scanning Calorimetry apparatus, TA Instruments Q2000, under isothermal conditions at a constant temperature of 124° C. 5-6 mg of sample were weighed and placed into aluminum DSC pans. The sample was heated at a rate of 20K/min up to 200° C. and cooled down at a rate of 20K/min to the test temperature, thereby erasing the thermal history. The isothermal test began immediately after. The time was recorded until crystallization occurs. The time interval until the crystallization heat flow maximum (peak), t_{maxDSC}, was determined using the vendor software (TA Instruments). The measurement was repeated 3× times. An average value was then calculated (in min). If no crystallization was observed under these conditions for more than 120 minutes, the value of t_{maxDSC}=120 minutes was used for further calculations of the HMWcopo index.

The melt viscosity η_{0.02} value was multiplied by the t_{maxDSC} value. The product was normalized by a factor of 100000 (10\hat{ }5).

### Molecular Weight Distribution Determination

The determination of the molar mass distributions and the means Mn, Mw, Mz, and Mw/Mn derived therefrom was carried out by high-temperature gel permeation chromatography using a method described in ISO 16014-1, -2, -4, issues of 2003. The solvent was 1,2,4-trichlorobenzene (TCB). The temperature of apparatus and solutions was 135° C. A PolymerChar (Valencia, Paterna 46980, Spain) IR-4 infrared detector, capable for use with TCB, was the concentration detector. A WATERS Alliance 2000, equipped with pre-column SHODEX UT-G and separation columns SHODEX UT 806 M (3×) and SHODEX UT 807 (Showa Denko Europe GmbH, Konrad-Zuse-Platz 4, 81829 Muenchen, Germany) connected in series, was used.

The solvent was vacuum distilled under nitrogen and stabilized with 0.025% by weight of 2,6-di-tert-butyl-4-methylphenol. The flowrate used was 1 ml/min. The injection was 500 μl. The polymer concentration was in the range of 0.01%<conc.<0.05% w/w. The molecular weight calibration was established by using monodisperse polystyrene (PS) standards from Polymer Laboratories (now Agilent Technologies, Herrenberger Str. 130, 71034 Boeblingen, Germany)) in the range from 580 g/mol up to 11600000 g/mol and additionally with hexadecane.

The calibration curve was then adapted to polyethylene (PE) by the Universal Calibration method (Benoit H., Rempp P. and Grubisic Z., & in J. Polymer Sci., Phys. Ed., 5, 753(1967)). The Mark-Houwing parameters used were for PS: k_{PS}=0.000121 dl/g, α_{PS}=0.706 and for PE k_{PE}=0.000406 dl/g, α_{PE}=0.725, valid in TCB at 135° C. Data recording, calibration, and calculation were carried out using NTGPC_Control_V6.02.03 and NTGPC_V6.4.24 (hs GmbH, Hauptstralße 36, D-55437 Ober-Hilbersheim, Germany) respectively.

### Melt Flow Index

Determined according to ISO 1133-1 2012-03 at 190° C. with the specified load.

### Long Chain Branching Index (LCBI)

The LCB index corresponds to the branching factor g′, measured for a molecular weight of 10⁶ g/mol. The branching factor g′, which allows determining long-chain branches at high Mw, was measured by Gel Permeation Chromatography (GPC) coupled with Multi-Angle Laser-Light Scattering (MALLS). The radius of gyration for each fraction eluted from the GPC (with a flow-rate of 0.6 ml/min and a column packed with 30 μm particles) was measured by analyzing the light scattering at the different angles with the MALLS (detector Wyatt Dawn EOS, Wyatt Technology, Santa Barbara, Calif). A laser source of 120 mW of wavelength 658 nm was used. The specific index of refraction was taken as 0.104 ml/g. Data evaluation was done with Wyatt ASTRA 4.7.3 and CORONA 1.4 software.

The parameter g′ is the ratio of the measured mean square radius of gyration to that of a linear polymer having the same molecular weight. Linear molecules show g′ of 1 while values less than 1 indicate the presence of LCB. Values of g′ as a function of mol. weight, M, were calculated from the equation:

$${g}^{′} ( M ) = < {Rg}^{2} {>}_{sample , M} / < {Rg}^{2} {>}_{linear ref . , M}$$

where <Rg²>, M is the root-mean-square radius of gyration for the fraction of mol. weight M.

The radius of gyration for each fraction eluted from the GPC (with a flow-rate of 0.6 ml/min and a column packed with 30 μm particles) was measured by analyzing the light scattering at the different angles. The mol. Weight M and <Rg²>_{sample,M} were determined, and the g′ was defined at a measured M=10⁶ g/mol. The <Rg²>_{linear ref,M} was calculated by the relation between radius-of-gyration and molecular weight for a linear polymer in solution (Zimm and Stockmayer W H 1949)) and confirmed by measuring a linear PE standard.

The testing procedure was as described in the following documents.
Zimm B H, Stockmayer W H (1949) The dimensions of chain molecules containing branches and rings. J Chem Phys 17
Rubinstein M., Colby R H. (2003), Polymer Physics, Oxford University Press

### Comonomer Content

The comonomer content was determined by IR in accordance with ASTM D 6248 98, using an FT-IR spectrometer Tensor 27 from Bruker, calibrated with a chemometric model for determining ethyl- or butyl-side-chains in PE for butene or hexene as comonomer, respectively. The result was compared to the estimated comonomer content derived from the mass-balance of the polymerization process and found to agree.

### Swell Ratio

The Swell-ratio was measured utilizing a capillary rheometer, Gottfert Rheotester2000 and Rheograph25, at T=190° C., equipped with a 30/2/2/20 die (total length 30 mm, Active length=2 mm, diameter=2 mm, L/D=2/2 and 200 entrance angle) and an optical device (laser-diod from Gottfert) for measuring the extruded strand thickness. The sample was melted in the capillary barrel at 190° C. for 6 min and extruded with a piston velocity corresponding to a resulting shear-rate at the die of 1440 s⁻¹.

The extrudate was cut (by an automatic cutting device from Gottfert) at a distance of 150 mm from the die-exit, at the moment the piston reaches a position of 96 mm from the die-inlet. The extrudate diameter was measured with the laser-diod at a distance of 78 mm from the die-exit, as a function of time. The maximum value corresponded to the D_{extrudate}. The swell-ratio was determined from the calculation:

$$SR = ( {D}_{extrudate} - {D}_{die} ) 100 \% / {D}_{die}$$

where D_{die} is the corresponding diameter at the die exit, measured with the laser-diod.

### Notched Tensile Impact Test AZK

The tensile-impact strength was determined using ISO 8256:2004 with type 1 double notched specimens according to method A. The test specimens (4×10×80 mm) were cut from a compression molded sheet which was prepared according to ISO 1872-2 (average cooling rate 15 K/min and high pressure during cooling phase). The test specimens were notched on two sides with a 45° V-notch. Depth was 2±0.1 mm and curvature radius on notch dip was 1.0±0.05 mm.

The free length between grips was 30±2 mm. Before measurement, the test specimens were conditioned at a constant temperature of −30° C. over a period of from 2 to 3 hours. The procedure for measurements of tensile impact strength, including energy correction following method A, is described in ISO 8256.

### ESCR Belltest

Environmental Stress Crack Resistance (ESCR Bell Telephone Test) was measured according to ASTM D1693:2013 (Method B) and DIN EN ISO 22088-3:2006. 10 rectangular test specimens (38×13×2 mm) were cut from a compression molded sheet, which was prepared according to ISO 1872-2 (average cooling rate 15 K/min and high pressure during cooling phase). The test specimens were notched with a razor to a depth of 0.4 mm parallel to the longitudinal axes, centered on one of the broad faces. Afterward, the test specimens were bent in a U-shape, with the notched side pointing upwards. Within 10 minutes from bending, the U-shaped specimens were put into a glass tube and filled with a 10% vol. aqueous solution of 4-Nonylphenyl-polyethylene glycol (Arkopal N100) at 50° C. and sealed with a rubber stopper. The specimens were inspected visually for cracks hourly on the first day, then daily, and, after 7 days, on a weekly basis (after 168 h). The final value obtained was the 50% failure point (F₅₀) of the 10 test specimen in the glass tube.

### Environmental Stress Cracking Resistance According to Full Notch Creep Test (FNCT)

The environmental stress cracking resistance of polymer samples was determined in accordance with international standard ISO 16770:2004 (FNCT) in aqueous surfactant solution. From the polymer sample, a compression molded 10 mm thick sheet was prepared. The bars with squared cross section (10×10×100 mm) were notched, using a razor blade, on four sides perpendicularly to the stress direction. A notching device described in M. Fleissner in Kunststoffe 77 (1987), pp. 45 was used for the sharp notch with a depth of 1.6 mm.

The load applied was calculated from tensile force divided by the initial ligament area. Ligament area was the remaining area=total cross-section area of specimen minus the notch area. For FNCT specimen: 10×10 mm²−4 times of trapezoid notch area=46.24 mm² (the remaining cross-section for the failure process/crack propagation). The test specimen was loaded with standard condition suggested by the ISO 16770 with constant load of 4 MPa at 80° C. or of 6 MPa at 50° C. in a 2% (by weight) water solution of non-ionic surfactant ARKOPAL N100. Time until rupture of test specimen was detected.

### Charpy aCN

Fracture toughness was determined by an internal method on test bars measuring 10×10×80 mm and cut from a compression molded sheet with a thickness of 10 mm. Six of these test bars were notched in the center using a razor blade in the notching device mentioned above for FNCT. The notch depth was 1.6 mm. The measurement was carried out substantially in accordance with the Charpy measurement method in accordance with ISO 179-1, with modified test specimens and modified impact geometry (distance between supports).

The test specimens were conditioned to the measurement temperature of −30° C. over a period of from 2 to 3 hours. A test specimen was then placed without delay onto the support of a pendulum impact tester in accordance with ISO 179-1. The distance between the supports is 60 mm. The drop of the 2 J hammer was triggered, with the drop angle being set to 160°, the pendulum length to 225 mm, and the impact velocity to 2.93 m/s. The fracture toughness value was expressed in kJ/m² and given by the quotient of the impact energy consumed and the initial cross-sectional area at the notch, aCN. Values for complete fracture and hinge fracture were used (see suggestion by ISO 179-1).

### Cast Film Measurement

The Film measurement of gels was carried out on an OCS extruder type ME 202008-V3 with 20 mm screw diameter and a screw length of 25 D with a slit die width of 150 mm. The cast line was equipped with a chill roll and winder (model OCS CR-9). The optical equipment consisted of a OSC film surface analyzer camera, model FTA-100 (flash camera system) with a resolution of 26 μm×26 μm. After purging the resin for 1 hour to stabilize the extrusion conditions, inspection and value recording took place for 30 minutes afterwards. The resin was extruded at 220° C. with a take-off speed of ca. 2.7 m/min, thereby generating a film with thickness 50 μm. The chill roll temperature was 70° C.

The inspection with the surface analyzer camera provided the total content of gels and the content of gels with diameter of higher than 700 μm, as reported in Table 1.

### E-Modulus

Tensile tests were carried out according to ISO 527-1:2019/-2:2012, Method B in norm climate (50% rel. humidity and 23° C.). ISO 20753:2018 Type A2 (=ISO 527-2 Type 1B) test specimens (h=4 mm, b₁=10 mm, b₂=20 mm, l₃≥150 mm, L₀=50 mm) were cut according to ISO 2818:2018, from a compression molded sheet, which was prepared according to ISO 293:2004 and ISO 17855-2:2016 (average cooling rate 15 K/min and 10 MPa during pressure and cooling phase). The cut out Type 1B test specimens were conditioned under norm climate conditions for >16 h, according to ISO 291:2008, and then measured on a Zwick Allround Z010 Linie, following the instruction in ISO 527-2. The E-Modulus was determined with 1 mm/min measuring velocity.

### Process Setup

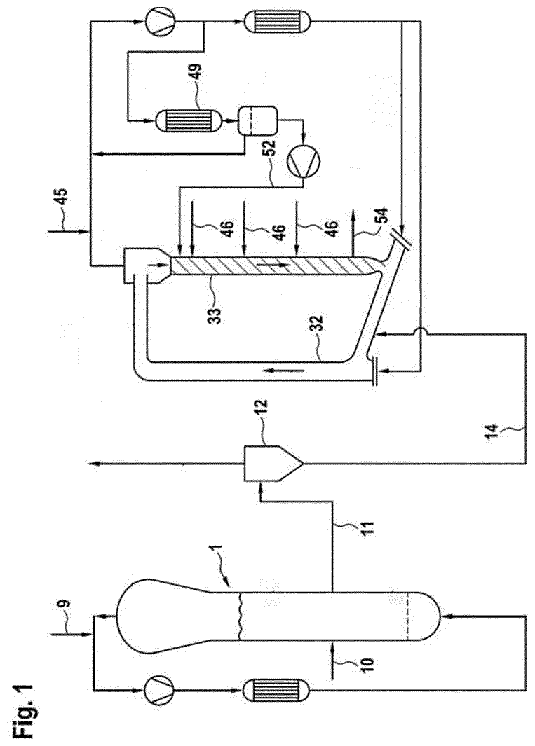

The polymerization process was carried out under continuous conditions in a plant having two serially connected gas-phase reactors, as shown in FIG. 1.

The polymerization catalyst was prepared as follows.

### Procedure for the Preparation of the Catalyst Component

A magnesium chloride and alcohol adduct containing about 3 mols of alcohol was prepared, following the method described in example 2 of U.S. Pat. No. 4,399,054, but working at 2000 RPM instead of 10000 RPM. The adduct was subjected to a thermal treatment, under nitrogen stream, over a temperature range of 50-150° C., until a weight content of 25% of alcohol was reached.

Into a 2 L four-necked round flask, purged with nitrogen, 1 L of TiCl₄ was introduced at 0° C. Then, at the same temperature, 70 g of a spherical MgCl₂/EtOH adduct containing 25% wt of ethanol were added under stirring. The temperature was raised to 140° C. in 2 h and maintained for 120 minutes. Then, the stirring was discontinued. The solid product was allowed to settle. The supernatant liquid was siphoned off. The solid residue was then washed once with heptane at 80° C. and five times with hexane at 25° C. and dried under vacuum at 30° C.

Into a 260 cm³ glass reactor provided with a stirrer, 351.5 cm³ of hexane and, under stirring, 7 g of the catalyst component were introduced at 20° C. While maintaining the internal temperature of the glass reactor at 20° C., 5.6 cm³ of tri-n-octylaluminum (TNOA) in hexane (about 370 g/l) and an amount of cyclohexylmethyl-dimethoxysilane (CMMS) such as to have molar ratio TNOA/CMMS of 50, were slowly introduced into the reactor. The temperature was brought to 10° C. After 10 minutes of stirring, 10 g of propylene were introduced into the reactor at the same temperature during a time of 4 hours. The consumption of propylene in the reactor was monitored, and the polymerization was discontinued when a theoretical conversion of 1 g of polymer per g of catalyst was deemed to be reached. Then, the whole content was filtered and washed three times with hexane at a temperature of 30° C. (50 g/l). After drying, the resulting pre-polymerized catalyst (A) was analyzed and found to contain 1.05 g of polypropylene per g of initial catalyst, 2.7% Ti, 8.94% Mg, and 0.1% Al.

### Internal Electron Donor Supportation on the Prepolymerized Catalyst

About 42 g of the solid prepolymerized catalyst were charged into a glass reactor purged with nitrogen and slurried with 0.8 L of hexane at 50° C.

Then, EthylAcetate was added dropwise (in 10 minutes) in such an amount to have a molar ratio of 1.7 between Mg of the prepolymerized catalyst and the organic Lewis base.

The slurry was kept under stirring for 2 h with 50° C. as internal temperature.

The stirring was stopped. The solid was allowed to settle. A single hexane wash was performed at room temperature, before recovering and drying the final catalyst.

### Example 1

### Polymerization

11 g/h of the solid catalyst with a molar feed ratio of electron donor/Ti of 8, were fed using 1 kg/h of liquid propane to a first stirred precontacting vessel, into which also triisobutylaluminum (TIBA) and diethylaluminumchloride (DEAC) were dosed. The weight ratio between triisobutylaluminum and diethylaluminumchloride was 7:1. The ratio between aluminum alkyls (TIBA+DEAC) to the solid catalyst was 5:1. The first precontacting vessel was kept at 50° C. with an average residence time of 30 minutes. The catalyst suspension of the first precontacting vessel was continuously transferred to a second stirred precontacting vessel, which was operated with an average residence time of 30 minutes and kept also at 50° C. The catalyst suspension was then transferred continuously to fluidized-bed reactor (FBR) (1) via line (10).

In the first reactor, ethylene was polymerized, using H₂ as molecular weight regulator, and in the presence of propane, as an inert diluent. 49 kg/h of ethylene and 210 g/h of hydrogen were fed to the first reactor via line 9. No comonomer was fed to the first reactor.

The polymerization was carried out at a temperature of 80° C. and at a pressure of 2.9 MPa. The polymer obtained in the first reactor was discontinuously discharged via line 11, separated from the gas into the gas/solid separator 12, and reintroduced into the second gas-phase reactor via line 14.

The polymer produced in the first reactor had a melt index MIE of about 87 g/10 min and a density of 0.969 kg/dm³.

The second reactor was operated under polymerization conditions of about 89° C., and a pressure of 2.5 MPa. The riser had an internal diameter of 200 mm and a length of 19 m. The downcomer had a total length of 18 m, an upper part of 5 m with an internal diameter of 300 mm, and a lower part of 13 m with an internal diameter of 150 mm. The second reactor was operated by establishing different conditions of monomers and hydrogen concentration within the riser 32 and the downcomer 33. The different conditions were established by feeding via line 52, 330 kg/h of a liquid stream (liquid barrier) into the upper part of the downcomer 33. The liquid stream had a composition different from that of the gas mixture present in the riser. The different concentrations of monomers and hydrogen within the riser, the downcomer of the second reactor, and the composition of the liquid barrier are indicated in Table 1. The liquid stream of line 52 came from the condensation step in the condenser 49, at working conditions of 52° C. and 2.5 MPa, wherein a part of the recycle stream was cooled and partially condensed. In the order shown in FIG. 1, a separating vessel and a pump were placed downstream of the condenser 49. The monomers to the downcomer were fed in 3 positions (lines 46). In dosing point 1, located just below the barrier, 12 kg/h of ethylene and 0.10 kg/h of 1-hexene were introduced. In dosing point 2, located 2.3 meters below dosing point, 2 kg/h of ethylene were introduced. In dosing point 3, located 4 meters below dosing point, 2 kg/h of ethylene were introduced. In each of the 3 dosing points, a liquid taken from stream 52 was additionally fed in ratio to ethylene of 1:1.5 kg/h of propane, 30 kg/h of ethylene, and 35 g/h of hydrogen were fed through line 45 into the recycling system.

The final polymer was discontinuously discharged via line 54.

Other details of the polymerization conditions are reported in Table 1.

The polymerization process in the second reactor produced relatively high molecular weight polyethylene fractions.

In Table 2, the properties of the final product are specified.

The first reactor produced around 52% by weight (split wt %) of the total amount of the final polyethylene resin produced by both first and second reactors.

The comonomer (hexene-1) amount was of about 0.1% by weight.

### Comparative Example 1

### Polymerization

10 g/h of the solid catalyst with a molar feed ratio of electron donor/Ti of 8, were fed using 1 kg/h of liquid propane to a first stirred precontacting vessel, into which also triisobutylaluminum (TIBA) and diethylaluminumchloride (DEAC) were dosed. The weight ratio between triisobutylaluminum and diethylaluminumchloride was 7:1. The ratio between aluminum alkyls (TIBA+DEAC) to the solid catalyst was 5:1. The first precontacting vessel was kept at 50° C. with an average residence time of 30 minutes. The catalyst suspension of the first precontacting vessel was continuously transferred to a second stirred precontacting vessel, which was operated with an average residence time of 30 minutes and kept also at 50° C. The catalyst suspension was then transferred continuously to fluidized-bed reactor (FBR) (1) via line (10).

In the first reactor, ethylene was polymerized, using H₂ as molecular weight regulator, and in the presence of propane, as an inert diluent. 50 kg/h of ethylene and 215 g/h of hydrogen were fed to the first reactor via line 9. No comonomer was fed to the first reactor.

The polymerization was carried out at a temperature of 80° C. and at a pressure of 2.9 MPa. The polymer obtained in the first reactor was discontinuously discharged via line 11, separated from the gas into the gas/solid separator 12, and reintroduced into the second gas-phase reactor via line 14.

The polymer produced in the first reactor had a melt index MIE of about 71 g/10 min and a density of 0.967 kg/dm³.

The second reactor was operated under polymerization conditions of about 85° C., and a pressure of 2.5 MPa. The riser had an internal diameter of 200 mm and a length of 19 m. The downcomer had a total length of 18 m, an upper part of 5 m with an internal diameter of 300 mm, and a lower part of 13 m with an internal diameter of 150 mm. The second reactor was operated by establishing different conditions of monomers and hydrogen concentration within the riser 32 and the downcomer 33. The different conditions were established by feeding via line 52, 330 kg/h of a liquid stream (liquid barrier) into the upper part of the downcomer 33. The liquid stream had a composition different from that of the gas mixture present in the riser. The different concentrations of monomers and hydrogen within the riser, the downcomer of the second reactor, and the composition of the liquid barrier are indicated in Table 1. The liquid stream of line 52 came from the condensation step in the condenser 49, at working conditions of 51° C. and 2.5 MPa, wherein a part of the recycle stream was cooled and partially condensed. In the order shown in FIG. 1, a separating vessel and a pump were placed downstream of the condenser 49. The monomers to the downcomer were fed in 3 positions (lines 46). In dosing point 1, located just below the barrier, 10 kg/h of ethylene and 0.45 kg/h of 1-hexene were introduced. In dosing point 2, located 2.3 meters below dosing point, 4 kg/h of ethylene were introduced. In dosing point 3, located 4 meters below dosing point, 4 kg/h of ethylene were introduced. In each of the 3 dosing points, a liquid taken from stream 52 was additionally fed in ratio to ethylene of 1:1.5 kg/h of propane, 32 kg/h of ethylene and 35 g/h of hydrogen were fed through line 45 into the recycling system.

The final polymer was discontinuously discharged via line 54.

Other details of the polymerization conditions are reported in Table 1.

The polymerization process in the second reactor produced relatively high molecular weight polyethylene fractions.

In Table 2, the properties of the final product are specified.

The first reactor produced around 49% by weight (split wt %) of the total amount of the final polyethylene resin produced by both first and second reactors.

The comonomer (hexene-1) amount was of about 0.4% by weight.

### Comparative Example 2

The polymer of the comparative example was a polyethylene composition produced in a slurry process in the presence of a Ziegler catalyst with butene-1 as comonomer, commercially available from Dow under the trademark 35060E XG21081404.

TABLE 1

| | Ex. 1 | Comp. 1 |
|---|---|---|
| Operative conditions first reactor | | |
| H₂/C₂H₄ Molar ratio | 2.8 | 2.6 |
| C₂H₄% | 10.7 | 10.3 |
| Density of A) (g/cm³) | 0.969 | 0.967 |
| MIE [2.16 kg] of A) (g/10 min.) | 87 | 71 |
| Split (wt. %) | 52 | 49 |
| Operative conditions second reactor | | |
| H₂/C₂H₄ Molar ratio riser | 0.5 | 0.35 |
| C₂H₄% riser | 10 | 12 |
| C₆H₁₂% riser | 0.06 | 0.17 |
| H₂/C₂H₄ Molar ratio downcomer | 0.07 | 0.10 |
| C₂H₄% downcomer | 6 | 5 |
| C₆H₁₂% downcomer | 0.05 | 0.4 |
| H₂/C₂H₄ Molar ratio barrier | 0.082 | 0.056 |
| C₂H₄% barrier | 6.1 | 7.0 |
| C₆H₁₂% barrier | 0.12 | 0.31 |

TABLE 2

| | Ex. 1 | Comp. 1 | Comp. 2 |
|---|---|---|---|
| Final Polymer properties | | | |
| MIP [5 kg] (g/10 min.) | 2.4 | 1.39 | 1.3 |
| MIF [21.6 kg] (g/10 min.) | 49.9 | 28 | 27.3 |
| MIF/MIP | 20.7 | 20.1 | 21.5 |
| MIE [2.16 kg] | 0.53 | 0.33 | — |
| Density (g/cm³) | 0.9606 | 0.959 | 0.958 |
| Swell ratio (%) | 193 | 167 | 166 |
| Mw (g/mol) | 252240 | 265973 | 194155 |
| Mz (g/mol) | 1751190 | 1525400 | 1462533 |
| Mw/Mn | 33.9 | 31.0 | 29.53 |
| LCBI | 0.56 | 0.63 | 0.7 |
| Comonomer content IR | 0.1 (C₆H₁₂) | 0.4 (C₆H₁₂) | 0.8 (C₄H₈) |
| (% by weight) | | | |
| η_{0.02} | 31481 | 36504 | 44846 |
| (η_{0.02}/1000)/LCBI | 56.2 | 57.6 | 64 |
| AZK −30° C. (kJ/m²) | 83.4 | 85.3 | 56.2 |
| Charpy aCN, T = −30° | 4.8 | 6.5 | 4.1 |
| C. (kJ/m²) | | | |
| Belltest at 50° C. | 84 | 226 | — |
| FNCT* 4 MPa/80° C. | 1.2 | 2 | 3.1 |
| (hours) | | | |
| FNCT* 6 MPa/50° C. | 7.7 | 12.6 | — |
| (hours) | | | |
| E-Modulus (ISO 527-2/ | 1520 | 1440 | — |
| 1B/50) (Mpa) | | | |
| Sum Gels/m² >450 μm | 1.7 | 3.0 | — |
| Sum Gels/m² >700 μm | 0.0 | 0.0 | — |
| Sum Gels/m² total | 443 | 264 | — |
| HMW COPO Index | 0.3 | 0.58 | — |
| ET | 10.1 | 5.8 | — |
| ER | 3.1 | 2.7 | — |

Notes:
C₂H₄ = ethylene;
C₆H₁₂ = hexene;
C₄H₈ = butene;
*aqueous solution of 2% Arkopal N100

1. A polyethylene composition having the following features:
1) a density from 0.957 to 0.968 g/cm³, determined according to ISO 1183-1:2012 at 23° C.;
2) a ratio MIF/MIP from 12 to 30, where MIF is the melt flow index at 190° C. with a load of 21.60 kg, and MIP is the melt flow index at 190° C. with a load of 5 kg, both determined according to ISO 1133-1 2012-03;
3) a MIF from 41 to 60 g/10 min.;
4) along-chain branching index, LCBI, equal to or greater than 0.45, wherein LCBI is the ratio of the measured mean-square radius of gyration R_{g}, measured by GPC-MALLS, to the mean-square radius of gyration for a linear PE having the same molecular weight; and
5) a ratio (η_{0.02}/1000)/LCBI, which is between η_{0.02} divided by 1000 and LCBI, from 45 to 75.

2. The polyethylene composition of claim 1, comprising:
an ethylene copolymer.

3. The polyethylene composition of claim 1, prepared in the presence of a Ziegler-Natta polymerization catalyst.

4. The polyethylene composition of claim 3, wherein the Ziegler-Natta polymerization catalyst comprises the product of a reaction of:
a) a solid catalyst component comprising a Ti compound supported on MgCl₂, wherein the solid catalyst component is obtained by contacting a titanium compound with MgCl₂, or a precursor Mg compound, optionally in the presence of an inert medium, thereby obtaining an intermediate product a′), then subjecting a′) to prepolymerization and contact with an electron donor compound;
b) an organo-Al compound; and optionally
c) an external electron donor compound.

5. The polyethylene composition of claim 1, having a feature selected from the following additional features:
a η_{0.02} from 25,000 to 38,000 Pa·s, wherein η_{0.02} is the complex shear viscosity at an angular frequency of 0.02 rad/s, measured with dynamic oscillatory shear in a plate-plate rotational rheometer at a temperature of 190° C.;
a comonomer content equal to or less than 0.3% by weight, with respect to the total weight of the composition;
a Mw equal to or higher than 230,000 g/mol, wherein Mw is the weight-average molecular weight, measured by GPC;
a Mz equal to or higher 1,000,000 g/mol, wherein Mz is the z-average molecular weight, measured by GPC;
a Mz/Mw equal to or higher than 5.8;
a MIE equal to or lower than 0.8 g/10 min., wherein MIE is the melt flow index at 190° C. with a load of 2.16 kg, determined according to ISO 1133-1 2012-03;
a MIP from 1 to 10 g/10 min.;
an ER equal to or higher than 1;
an ET equal to or lower than 25; and
a HMWcopo index from 0.1 to 3;
wherein the HMWcopo index is determined according to the following formula:
HMWcopo=(η_{0.02}=t_{maxDSC})/(10\hat{ }5)
wherein
η_{0.02} is the complex shear viscosity at an angular frequency of 0.02 rad/s, measured with dynamic oscillatory shear in a plate-plate rotational rheometer at a temperature of 190° C.; and
t_{maxDSC} is the time, in minutes, to reach the maximum value of heat flow (in mW) of crystallization (time at which the maximum crystallization rate is achieved, equivalent to the t1/2 crystallization half-time) at a temperature of 124° C. under quiescent conditions, measured in isothermal mode in a differential scanning calorimetry apparatus, DSC.

6. The polyethylene composition of claim 1, comprising:
A) 30-70% by weight of an ethylene homopolymer or copolymer with a density equal to or greater than 0.960 g/cm³ and a MIE of 65 g/10 min. or higher;
B) 30-70% by weight of an ethylene copolymer, having a MIE value lower than the MIE value of A).

7. The polyethylene composition of claim 6, having a difference between the density value of component A) and the density value of the composition of equal to or lower than 15 kg/m³.

8. An article of manufacture comprising:
the polyethylene composition of claim 1.

9. The article of manufacture according to claim 7, wherein the article is a blow-molded article.

10. A process for preparing the polyethylene composition of claim 1, wherein the polymerization steps are carried out in the presence of a Ziegler-Natta polymerization catalyst supported on MgCl2.

11. The process of claim 10, comprising the steps of, in any order:
a) polymerizing ethylene, optionally together with one or more comonomers, in a gas-phase reactor in the presence of hydrogen; and
b) copolymerizing ethylene with one or more comonomers in another gas-phase reactor in the presence of an amount of hydrogen less than step a),
wherein, in at least one of the gas-phase reactors, the growing polymer particles flow upward through a first polymerization zone under fast fluidization or transport conditions, leave the first polymerization zone, and enter a second polymerization zone through which the polymer particles flow downward under the action of gravity, leave the second polymerization zone, and are reintroduced into the first polymerization zone, thereby establishing a circulation of polymer between the two polymerization zones.
